(19) United States
(12) Patent Application Publication
(10) Pub. No.: US 2012/0185205 A1
(43) Pub. Date: Jul. 19, 2012

(54) METHOD OF DETECTING PARASITIC MOVEMENTS WHILE ALIGNING AN INERTIAL UNIT

(75) Inventors: Lionel Rosellini, Paris (FR); Yannick Foloppe, Paris (FR)

(73) Assignee: SAGEM DEFENSE SECURITE, Paris (FR)

(21) Appl. No.: 13/497,218

(22) PCT Filed: Oct. 13, 2010
(86) PCT No.: PCT/EP2010/006245

§ 371 Date: Mar. 20, 2012

Related U.S. Application Data
(60) Provisional application No. 61/312,504, filed on Mar. 10, 2010.

(30) Foreign Application Priority Data
Oct. 15, 2009 (FR) 0904947

(51) Int. Cl. G06F 15/00; G01P 15/02

(52) U.S. Cl. 702/141

(57) ABSTRACT

A method of detecting parasitic movements while aligning an inertial unit comprising a navigation unit connected to accelerometer sensors and gyros disposed in a predetermined frame of reference, the method comprising the steps of: integrating the acceleration signal in a frame of reference that is turning in accordance with the measurement of the gyros so as to obtain a raw position signal during a predetermined duration; during this predetermined duration recording the previously calculated position signals; from an error model, determining the parameters for modeling the raw position signal; calculating a residual signal between the modeling signal and the raw position signal; and identifying a parasitic movement when the residual signal overshoots a predetermined limit threshold.

### FIELD OF THE INVENTION

The present invention relates to a method of detecting parasitic movements while aligning an inertial unit.

### BACKGROUND OF THE INVENTION

An inertial unit generally comprises a processor unit connected to sensors, such as accelerometers and gyros, placed on axes of a predetermined frame of reference in order to measure linear movements parallel to said axes and angular movements about said axes. The processor unit includes a navigation module for determining an attitude on the basis of the signals delivered by the sensor and it generally implements a Kalman filter in order to eliminate errors affecting the measurements of the sensors.

The use of an inertial unit is preceded by an operation of aligning the unit, during which the inertial unit needs to detect the vertical by measuring acceleration, and to determine the direction of North by measuring terrestrial rotation. During this operation, and in the absence of other information such as information of the global positioning system (GPS), speedometer, odometer, . . . type, the inertial unit needs to be completely stationary so as to avoid disturbing the measurements that serve to initialize navigation calculations.

It is found, more particularly with portable inertial units, that the inertial unit cannot be kept completely stationary throughout the time required for the alignment operation (even if it is placed directly on the ground or on a tripod, e.g. when the ground itself is loose). It is therefore necessary to detect these movements, either to take them into account for alignment purposes, or else to provide the user with an indication of the validity of measurement conditions, or indeed to request better stabilization of the inertial unit prior to restarting alignment. Four types of parasitic movements can be identified: movements of large amplitude and short duration (also known as short-term movement); movements of large amplitude and long duration (also known as long-term movement); movements of small amplitude and short duration; and movements of small amplitude and long duration.

There is no particular problem in detecting movements of the first three types and this is already handled in the state of the art. For example, detecting short-term and long-term movements of large amplitude is done by using the measurements of the accelerometers, possibly after filtering, and by comparing the measurements with thresholds. The thresholds are defined as a function of sensor noise and of the performance desired for detection. Detecting short-term movements of small amplitude is performed by monitoring certain parameters of the Kalman filter. For example, it is possible to compare innovation in the state of the Kalman filter during a measurement with thresholds that reveal such movements. These thresholds are defined as a function of the covariance of the innovation, as calculated by the Kalman filter, itself set as a function of the performance of the sensors.

In contrast, it is difficult to detect movements of the fourth type since the order of magnitude of these movements is comparable to the order of magnitude of sensor errors.

Methods exist that make use of a plurality of Kalman filters and that enable movements to be detected that have durations that are of short to medium length. Those methods are very expensive in terms of calculation and they are found to be relatively ineffective with movements of the fourth type.

### OBJECT AND SUMMARY OF THE INVENTION

An object of the invention is to provide a method that is simple and reliable for detecting movements of small amplitude and long duration, and without requiring any particular additional equipment.

To this end, the invention provides a method of detecting parasitic movements while aligning an inertial unit that comprises a navigation unit connected to accelerometer and angle sensors placed in a predetermined frame of reference, the method comprising the steps of:
integrating the signals from the sensors, in a frame of reference that is turning in an orientation that can be detected by the accelerometer and angle sensors, in order to obtain a raw position signal during a predetermined duration;
recording the raw position signal during said predetermined duration;
determining the parameters of a theoretical signal modeling the raw position signal as a function of a predetermined error model in the absence of movement;
calculating a residual signal between the theoretical modeling signal and the raw position signal; and
identifying a parasitic movement when the residual signal overshoots a predetermined limit threshold.

Thus, residues are calculated a posteriori between the modeling signal and the position signal obtained by double integration of the signals from the accelerator and angle sensors. These residues are used to determine whether parasitic movements have taken place during at least a portion of the duration of the alignment operation.

Preferably, the parameters are determined from the raw position signal by using a least-squares method.

This method of adjustment is simple and effective.

Also preferably, the determined parameters are compared with likelihood thresholds that are established as a function of the performance of the sensors.

The likelihood thresholds take account of the detectability limits of the sensors. This makes it possible to identify a movement that might have an influence on the position and that might have the same signature as a sensor error.

In an advantageous implementation, the threshold is also calculated to take account of a standard deviation value for the noise of the accelerometer and angle sensors, and preferably, the threshold is equal to six times the standard deviation value.

A threshold proportional to the theoretical standard deviation of the residual signal enables parasitic movements to be detected effectively and makes it possible to quantify the probability of false alarms. In particular by using the error model of the sensor, the standard deviation value of the residual signal is calculated a priori as a function of the time that has elapsed since the beginning of modeling. It then suffices to compare the residual signal with the standard deviation values as calculated in this way since the beginning of modeling in order to identify an anomaly in the residual signal and thus detect a parasitic movement.

Also advantageously, the method includes the step of filtering the raw position signal prior to modeling in order to eliminate therefrom components having a frequency greater than a predetermined maximum threshold.

High-frequency vibration of small amplitude that does not disturb the alignment operation could give rise to false alerts when detecting movements. This filtering enables that risk to be eliminated.

Preferably, identification takes account of a number of times the limit threshold is overshot by the residual signal.

This amounts to detecting a parasitic movement when some predetermined number of residues overshoot the predetermined threshold during a predetermined length of time. This characteristic makes it possible to avoid a false detection of movement when overshooting of the thresholds is due merely to adding together all of the sensor noise or to a movement that is very localized in time. However such circumstances are rare.

Other characteristics and advantages of the invention appear on reading the following description of a particular and non-limiting implementation of the invention.

### BRIEF DESCRIPTION OF THE DRAWING

Reference is made to the accompanying drawing, in which:

FIG. 1 is a diagrammatic of an inertial unit; and

FIG. 2 is a diagram comparing the residual signal with the predetermined threshold, with time being plotted along the abscissa and distance up the ordinate.

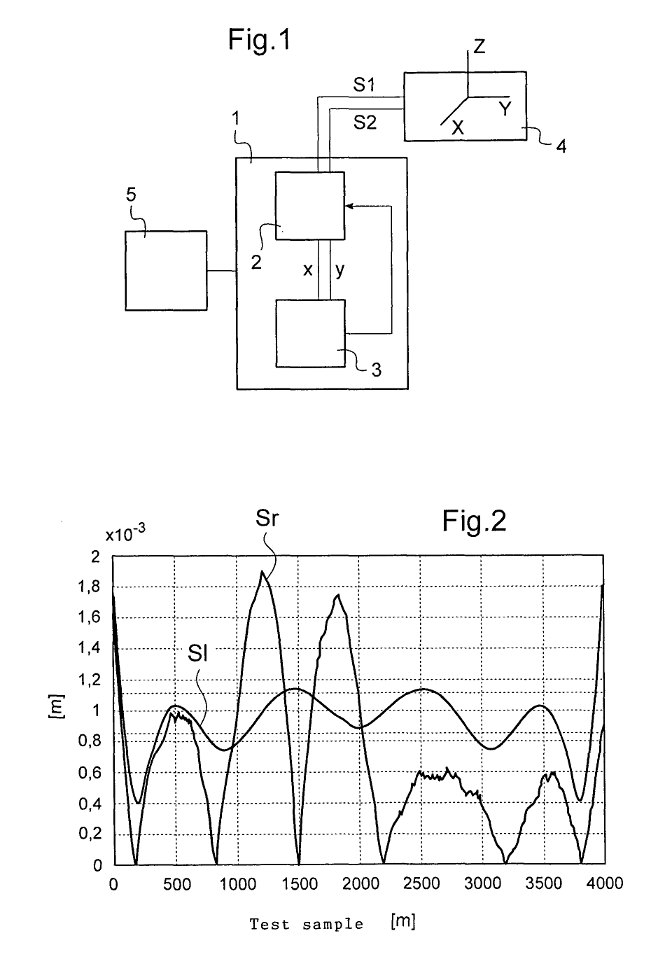

### MORE DETAILED DESCRIPTION

The inertial unit for implementing the method in accordance with the invention comprises a processor unit 1 having a navigation module 2 and a Kalman filter 3, and it is connected to sensors 4 and to a user interface 5.

The sensors 4 comprise accelerometers and gyros (free gyros or rate gyros) disposed on the axes X, Y, and Z of a frame of reference for delivering signals S1 and S2 representative respectively of an acceleration along each of these axes and of a speed of rotation about each of these axes.

The navigation unit 2 is arranged to integrate the signals S1 and S2 so as to measure linear and angular movements relative to said axes and so as to provide position signals x and y.

The Kalman filter 3 uses the position signals x and y for estimating the attitude errors, the bias, and the drifts of each of the sensors.

In nominal mode, the operation of the inertial unit is conventional.

However, nominal mode is preceded by an alignment operation in which the method of the invention is implemented for detecting parasitic movements. This method is particularly intended for detecting movements of small amplitude and long duration. Movements of large amplitude and short or long duration, and movements of small amplitude and short duration are detected by conventional methods (respectively from the signals S1, S2 and from the parameters of the Kalman filter).

The method of the invention begins by double integration of the acceleration signals S1 and S2, projected onto a frame of reference that is turning in compliance with the rotation as measured by the gyros, so as to obtain a raw position signal x′ and a raw position signal y′ over a predetermined duration. This predetermined duration may be less than or equal to the duration of the alignment. It is also possible to implement the method over one or more time windows during alignment. The time windows may also overlap.

The following step consists in recording the position signals x′ and y′ for a predetermined duration.

It is known that sensor errors give rise to errors in the measured displacements such that the displacement, dep, along each axis as a function of time can be modeled by a polynomial function of the fourth degree:

dep=a₀+a₁t+a₂t²+a₃t³+a₄t⁴

The terms a₀, a₁, a₂, a₃, and a₄ are parameters representative of an error, and respectively they concern the initial position, the speed, the acceleration, rotation about the axes X and Y, and rotation about the axis Z.

From this error model, the parameters a₀, a₁, a₂, a₃, and a₄ are determined (for each axis X, Y) in the theoretical signal that models the raw position signal. These parameters are determined from the raw position signal, e.g. by using a least squares method to adjust the modeling signal to the raw position signal. Once the parameters a₀, a₁, a₂, a₃, and a₄ have been determined in this way, they are compared with likelihood thresholds that are established as a function of sensor performance.

The following step consists in calculating a residual signal between the modeling signal and the raw position signal.

A parasitic movement is identified and an alert is triggered (e.g. in the form of incrementing or displaying an indicator concerning alignment conditions on the user interface 5), whenever the residual signal overshoots a predetermined limit threshold. More precisely, it is the absolute value of the residual signal Sr that is compared with a likely threshold signal Sₗᵢₘ as a function of time (see FIG. 2). In the preferred implementation, the limit threshold is calculated to take account of a standard deviation value for accelerometer and gyro noise. The sensor error model serves in particular to calculate a priori a value for the standard deviation of the residues as a function of the time that has elapsed since the beginning of the modeling. The threshold signal Sₗᵢₘ is representative of a multiple of the standard deviation value as calculated in this way. The multiple that is selected is a result of a compromise between sensitivity in detecting parasitic movements and an acceptable risk of a false alert (when a parasitic movement is detected even though one does not exist). Here the multiple is six.

The identification test takes account of a number of times the limit threshold Sₗᵢₘ is overshot by the residual signal Sr. There, the maximum threshold is set at 10. Once more, the choice of a maximum threshold for the number of overshoots is the result of a compromise between sensitivity in detecting parasitic movements and an acceptable risk of a false alert.

FIG. 2 thus shows the arrival of a parasitic movement during an alignment operation.

The method here further comprises a prior step of filtering the raw position signal x′, y′ before modeling in order to eliminate therefrom components having a frequency greater than a predetermined maximum threshold. The predetermined maximum threshold is set so that a risk of low-amplitude high-frequency vibration that does not disturb the alignment operation does not give rise to false alerts in the detection of movements.

Naturally, the invention is not limited to the implementations described but covers any variant coming within the field of the invention as defined by the claims.

In particular, the limit threshold may be constant, the prior filtering may be omitted, mean accelerations over time intervals may be used instead of instantaneous accelerations, . . . .

Furthermore, the limit threshold may be a multiple of the standard deviation other than six, and the maximum overshoot threshold may be other than one.

What is claimed is:

1. A method of detecting parasitic movements while aligning an inertial unit that comprises a navigation unit connected to accelerometer and angle sensors placed in a predetermined frame of reference, the method comprising the steps of:
integrating the signals from the sensors, in a frame of reference that is turning in an orientation that can be detected by the accelerometer and angle sensors, in order to obtain a raw position signal during a predetermined duration;
recording the raw position signal during said predetermined duration;
determining the parameters of a theoretical signal modeling the raw position signal as a function of a predetermined error model in the absence of movement;
calculating a residual signal between the theoretical modeling signal and the raw position signal; and
identifying a parasitic movement when the residual signal overshoots a predetermined limit threshold.

2. A method according to claim 1, wherein the parameters are determined from the raw position signal by using a least squares method.

3. A method according to claim 1, wherein the determined parameters are compared with likelihood thresholds that are established as a function of the performance of the sensors.

4. A method according to claim 1, wherein the threshold is calculated to take account of a standard deviation value for the noise of the accelerometer and angle sensors.

5. A method according to claim 4, wherein the threshold is equal to a multiple of the standard deviation value, and in particular is six times the standard deviation value.

6. A method according to claim 4, wherein the threshold is constant.

7. A method according to claim 4, wherein the threshold varies as a function of time.

8. A method according to claim 1, including the step of filtering the raw position signal prior to modeling in order to eliminate therefrom components having a frequency greater than a predetermined maximum threshold.

9. A method according to claim 1, wherein identification takes account of a number of times the limit threshold is overshot by the residual signal.
